(19) United States
(12) Patent Application Publication
(10) Pub. No.: US 2007/0268270 A1
(43) Pub. Date: Nov. 22, 2007

(54) TOUCH OPERATION INPUT DEVICE

(75) Inventors: Mikio Onodera, Miyagi-ken (JP); Ken Shibazaki, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/749,072

(22) Filed: May 15, 2007

(30) Foreign Application Priority Data
May 16, 2006 (JP) 2006-136926

(51) Int. Cl. G06F 3/041

(52) U.S. Cl. 345/173

(57) ABSTRACT

A touch operation input device, such as used in an automobile, controls selective manipulation of a functional item from among a plurality of installation devices when an operator cannot see a manipulation surface or a display screen of the input device. The touch operation input device operates by selective detection of the presence of a finger in areas of the manipulation surface corresponding to the plurality of installation devices.

### RELATED APPLICATIONS

This application claims the benefit of priority under 35 U.S.C. § 119 to Japanese Patent Application No. 2006-136926 filed on May 16, 2006, which is hereby incorporated by reference in its entirety.

### BACKGROUND

1. Technical Field

The disclosure relates to a touch operation input device which selects a desirable functional item among a plurality of functional items concerning a plurality of vehicle installations such as an air conditioner, an audio, and a navigation system in an automobile.

2. Description of the Related Art

As a known touch operation input device, for example, a first prior art device is disclosed in JP-A-2000-194427 and a second prior art device is disclosed in JP-A-1999-105646.

The first prior art device includes an input unit which has a manipulation surface touched by a finger so as to output a position signal showing a position on the manipulation surface touched by the finger and a functional item selecting unit which selects one functional item among a plurality of functional items corresponding to a plurality of vehicle installations on the basis of the position signal.

The first prior art device also includes a display unit. The display unit is set so as to display a screen in which a plurality of icons showing the plurality of functional items is displayed in a predetermined arrangement. In addition, the display unit is set so as to display an icon showing a functional item selected by the functional item selecting unit by emphasizing the icon more than other icons.

The first prior art device also includes a vibration control unit which selects a vibration pattern representing a functional item selected by the functional item selecting unit and a vibration generating unit which vibrates a manipulation surface with a vibration pattern selected by the vibration control unit among a plurality of vibration patterns stored in advance.

In addition, in the first prior art device, the plurality of functional items and the plurality of areas configured on the manipulation surface with a finger are respectively correlated together. In addition, a process for selecting the functional item on the basis of the position signal operated by the function selecting unit includes a process for determining whether a position shown by a position signal is included in a certain area of a plurality of areas and a process for selecting a functional item correlated with the determined area among the plurality of the functional items.

The first prior art device as configured above operates as follows.

When an operator touches a manipulation surface with his finger, the input unit outputs a position signal showing a position on the manipulation surface with his finger. The position signal is inputted to the functional item selecting unit. The functional item selection unit to which the position signal is inputted determines whether the position shown by the position signal is included in a certain area of a plurality of areas on the manipulation surface configured previously and selects the functional item correlated to the determined area among the plurality of functional items.

In this case, the display unit displays the icon showing the functional item selected by the functional item selecting unit by emphasizing it more than other icons.

In addition, the vibration control unit selects a vibration pattern indicating a functional item selected by the functional item selecting unit among a plurality of vibration patterns stored in advance and vibrates the manipulation surface by using the vibration generating unit on the basis of the selected vibration pattern.

As mentioned above, the operator compares a predetermined array of the plurality of icons on a screen with a plurality of arrays configured on the manipulation surface. The area on the manipulation surface is correlated to an icon showing a desirable functional item by the touch of a finger to select a desirable functional item among the plurality of functional items.

In addition, the operator confirms whether a desirable functional item is selected by determining that a vibration pattern of the manipulation surface is correlated to a desirable functional item. Accordingly, the operator does not confirm whether the icon correlated to the desirable functional item is more emphasized than other icons.

The second prior art device includes an input unit having a manipulation surface touched by a finger so as to output a position signal indicating a position on the manipulation surface on the basis of the position signal. The functional item selecting unit selects one functional item among a plurality of functional items related to a plurality of vehicle installations.

The second prior art device also includes display unit, which is set so that a plurality of icons indicating a plurality of functional items are displayed in a screen arranged in a predetermined array. Each icon surrounds a predetermined icon among a plurality of icons and each of the other icons is adjacent to a predetermined icon. In addition, the display unit is set in advance so that an icon indicating a functional item selected by the functional item selecting unit is emphasized more than the other icons so as to be displayed.

In addition, in the second prior art device, the functional item selecting unit stores, in advance, the directions toward all icons adjacent to each item from a predetermined icon, and the directions are converted to XY coordinates.

In addition, in the second prior art device, a process of selecting a functional item based on a position signal performed by the functional item selecting unit will be described in the following first, second, and a third processes.

In the first process, a moving direction on a manipulation surface touched by a finger is converted in a direction on the XY coordinates. In the second process, a calculated direction in the first process and each direction on the XY coordinates that are stored in advance are compared. In the third process, a functional item is selected if it is determined to correspond to each direction in the second process.

The above mentioned second prior art device operates as follows.

When an operator touches the manipulation surface by her finger, the input unit outputs a position signal indicating a position on the manipulation surface touched by the finger. The position signal is inputted to the functional item selecting unit. When the operator moves her finger in a direction such that the finger is on the manipulation surface, the position signal varies in accordance with the movement of the finger. The functional item selecting unit then converts the direction of the finger movement to XY coordinates through a process based on the movement direction of the finger on the manipulation surface. Next, in the second process, each direction on the XY coordinates stored in advance is compared with a calculated direction from the first process. Next, the third process is performed, in which a functional item determined to correspond to the determined direction is selected.

In addition, when the functional item is selected by the functional item selecting unit, a display unit emphasizes an icon indicating the selected functional item more than other icons.

As above-mentioned, the operator of the second prior art device moves the finger on the manipulation surface in a direction from an icon indicating a predetermined functional item to an icon indicating a desirable functional item. Accordingly, a desirable functional item may be selected among a plurality of functional items.

In the above-mentioned first prior art devices, because it is possible to confirm that a desirable functional item is selected by judging whether a vibration pattern on the manipulation surface corresponds to the desirable functional item, an icon corresponding to the desirable functional item is emphasized on a screen more than other icons and the process ends without confirming the process. However, when the operator allows a finger to be disposed on the area corresponding to a desirable functional item among a plurality of configured areas on the manipulation surface, the operator should see and confirm the area where to be positioned on the manipulation surface.

On the other hand, in the above-mentioned second prior art device, when the moving direction of the finger corresponding to a direction toward each icon of all the icons is stored from the icon indicating the predetermined functional item, the desirable functional item may be selected without seeing the manipulation surface. However, when the operator does not see whether the icon corresponding to the desirable functional item is more emphasized in a screen than other icons, it is not possible to confirm that the desirable functional item may be selected.

### SUMMARY

In various aspects of the disclosure, a touch operation input device is provided that easily controls selective manipulation of a functional item from among a plurality of installation devices when a user cannot see a manipulation surface of an input unit or a screen displayed by the display unit.

According to an aspect of the disclosure, a touch operation input device includes an input unit having a manipulation surface to sense the presence of a finger and outputs a position signal indicating a position on the manipulation surface approached by the finger. A functional item selecting unit selects a functional item among a plurality of functional items on the basis of the position signal. A vibration generating unit vibrates the manipulation surface, and a vibration control unit controls the vibration generating unit.

In the touch operation input device, the functional item selecting unit is configured to correlate a predetermined functional item among the plurality of functional items with an initial area including an initial position on the manipulation surface for selection, and to respectively correlate the functional items other than the predetermined functional item with other areas including predetermined positions in known relationship with the initial area.

The functional item selecting unit selects the predetermined functional item when a position indicated by the position signal is within the initial area and selects a functional item correlated with other areas among the other functional items when the position indicated by the position signal is within one of the other areas.

The vibration control unit selects a vibration pattern indicating the functional item selected by the functional item selecting unit among a plurality of vibration patterns, and is configured to control the vibration generating unit so that the manipulation surface is vibrated with the selected vibration pattern.

In one embodiment, when a finger approximates a position where the finger does not touch the manipulation surface, the input unit outputs the initial signal indicating the initial position. The functional item selecting unit inputs the initial position signal, in which the initial area including the initial position indicated by the initial position signal are correlated with the predetermined functional items among a plurality of functional items. Accordingly, in the functional item selecting unit, each of the other areas are respectively correlated with the other functional items other than the predetermined functional items that have a relationship with the initial area. The functional item selection unit selects the predetermined functional item when the position indicated by the position signal is within the initial area by configuring the corresponding relationship between each of the functional items and each area on the manipulation surface. Accordingly, when the position indicated by the position signal is within one position of the other area, the functional item selection unit selects the functional item corresponding to the other areas.

Accordingly, a predetermined functional item is selected when the operator approximates the manipulation surface with his finger without touching the manipulation surface. In addition, as the relationship between the movement direction of the finger from the initial position and each of the functional items correspond to the other than predetermined functional items, the operator may easily remember the movement of his finger so as to select each of the other functional items other than the predetermined functional item.

In addition, when the functional item is selected by the functional item selecting unit, the functional item selecting unit selects the vibration pattern indicating the functional item selected by the functional item selecting unit among the plurality of vibration patterns and vibrates the manipulation surface with the selected vibration pattern by the vibration generating unit.

Accordingly, the operator may confirm whether a desirable functional item is selected or whether the vibration pattern on the manipulation surface corresponds to the desirable functional item. Accordingly, the operator ends the manipulation without seeing the screen.

According to the disclosure, the operator may embody the touch operation input device in a state where the operator does not see the manipulation surface of the input unit and a displayed screen.

According to the disclosure, the touch operation input device in which the manipulation of the functional item is easily selected is embodied in a state where the operator does not see the manipulation surface of the input unit and the displayed screen. Accordingly, it is possible to enhance the manipulation of the touch operation input device and to do so safely when driving an automobile.

### BRIEF DESCRIPTION OF THE DRAWINGS

FIG. 1 is a block diagram illustrating a schematic configuration according to an embodiment of the disclosure.

FIG. 2 is a schematic diagram illustrating a manipulation device according to the embodiment shown in FIG. 1.

FIG. 3 is an example illustrating an installation of a display device and the manipulation device in an automobile according to the embodiment shown in FIG. 1.

FIGS. 4 and 5 are connecting flow charts illustrating processing steps performed in a CPU as shown in FIG. 1.

FIG. 6 is a diagram illustrating a corresponding relationship between a position on a manipulation surface touched by a finger of a user and a vibration pattern.

FIG. 7 is a diagram illustrating an example of a screen varied by the process described in FIGS. 4 and 5.

### DESCRIPTION OF THE PREFERRED EMBODIMENTS

A touch operation input device will be described with reference to the drawings according to an embodiment of the disclosure.

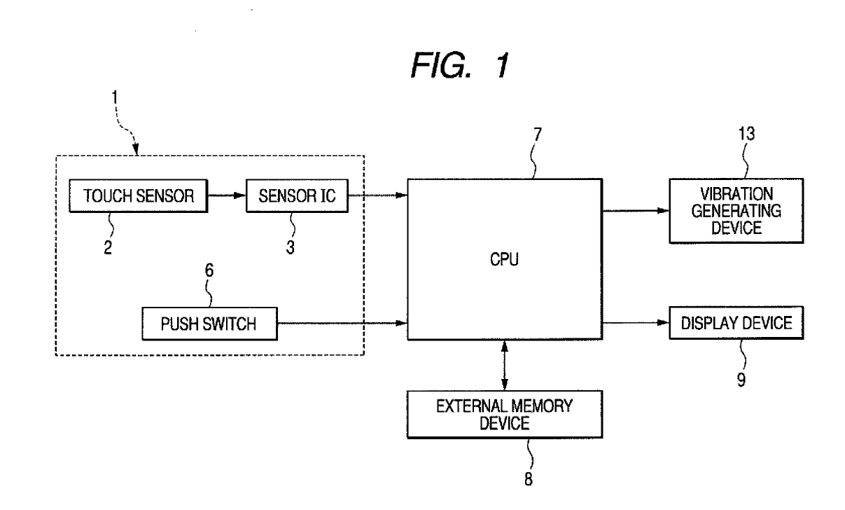

FIG. 1 is a block diagram illustrating a schematic configuration according to an embodiment of the disclosure. As shown in FIG. 1, the embodiment includes a manipulation device 1 which generates a signal so as to input the signal to a CPU 7 and outputs the signal. The manipulation device 1 includes a touch sensor 2 and a sensor IC 3. The touch sensor 2 includes a sensor to detect the approach of a human, for example, with use of a capacitive sensor. When the touch sensor 2 detects the approach of the human, a position signal indicating a position on the manipulation surface 5 adjacent to the human is outputted to the sensor IC 3. The sensor IC 3 converts a position signal from the touch sensor 2 into a position signal outputted to the CPU 7 for operation on by the CPU 7.

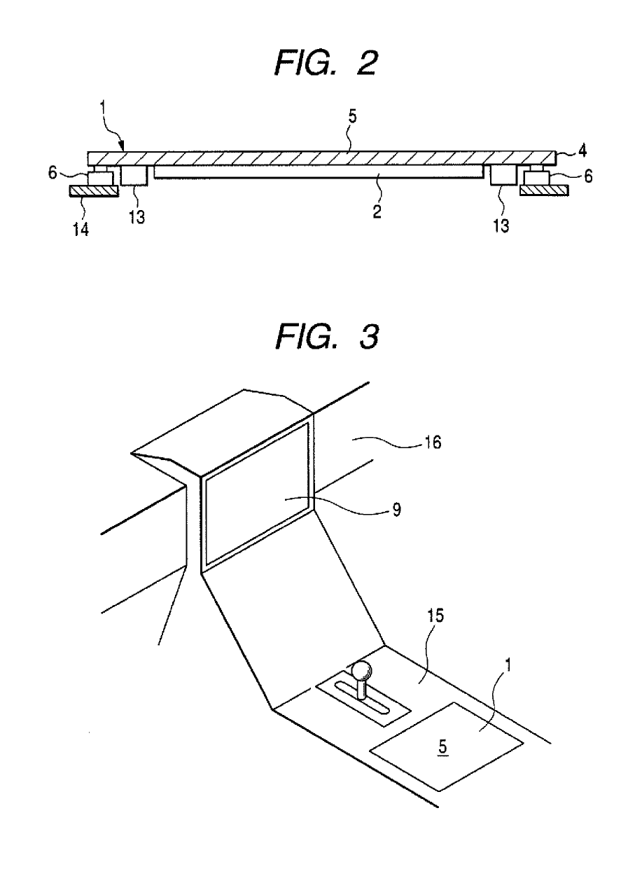

FIG. 2 is a schematic diagram illustrating a manipulation device according to the embodiment shown in FIG. 1. As shown in FIG. 2, the touch sensor 2 has a plate. An acryl panel 4 is fixed on an upper surface of the touch sensor 2. The acryl panel 4 covers an entire upper surface of the touch sensor 2. The upper surface of the acryl panel 4 is formed as the manipulation surface 5 touched by a finger when an input manipulation is performed.

In one embodiment, an input unit outputs a position signal indicating a position on the manipulation surface 5 touched by the finger. The input unit includes at least the touch sensor 2, the sensor IC 3, and the acryl sensor 4.

As shown in FIG. 1, the CPU 7 is connected to an external memory device 8. The CPU 7 is configured in advance among a plurality of vehicle installations mounted to an automobile by a program stored previously in the external memory device 8 on the basis of a position signal from the sensor IC 3 or input unit. The plurality of functional items may include, for example, three devices: an air conditioner (hereinafter, refer to as “air con”), an audio, and a navigation system (hereinafter, refer to as “navi”). Other devices such a video, power control of windows or mirrors, or other auxiliary devices may also be included.

The CPU 7 is set in advance as following processes (1) to (4) so as to select a functional item on the basis of the position signal when the functional item selecting unit functions.

(1) The CPU 7 is configured in advance so as to convert the process from a waiting state to an operating state on the basis of the position signal.

(2) The CPU 7 is configured in advance so that an initial position on the manipulation surface 5 is tracked despite being the finger does not touch the manipulation surface. For example, an initial area including an initial position Pf indicating the position signal which is a cause of converting from a waiting state to an operating state, and a predetermined functional item, e.g. the air con, are correlated together. That is, a center area C (FIG. 5) may be formed of a predetermined rectangular area in which the initial position Pf is in the center area, is set in advance so that the center area C is correlated with the air con which is a functional item.

(3) The CPU 7 is configured in advance so that each of the two areas having a predetermined relationship to the center area C (initial area) includes the initial position Pf in a different position and the audio and navi which are other functional items other than the air con are respectively correlated. That is, a left area L adjacent to the left side of the center area C is set in advance so that the left area L is correlated with the audio, a functional item. A right area R adjacent to a right side of the center area C is set so that the right area R is correlated with the navi, also a functional item. The left area L, in which a position P1 is in the center far away from the initial position Pf in a left direction, has the same shape and the same size as the center area C. The right area R, in which a position Pr is in the center far away from the initial position Pf in a right direction, has the same shape and the same size as the center area C.

(4) The CPU 7 is configured to select the air con when a position indicated by the position signal is within the center area C. The CPU 7 is configured to select the audio in advance when the position indicated by the position signal is within the left area L. The CPU 7 is configured to select the navi in advance when the position indicated by the position signal is within the right area R.

In addition, the manipulation device 1 includes a push switch 6 which is pressed so as to output a pressing signal. The CPU 7 is configured in advance so as to be functioned as a selection determining unit by a program stored previously in the external memory device 8. The selection determining unit is a unit in which the currently selected functional item is actually selected by the functional item selecting unit at the time of inputting a pressing signal.

The push switch 6, as shown in FIG. 2, for example, includes a pair of switches in a fixed member 14. The acryl panel 4 is disposed between a pair of push switches 6 such that the fixed member 14 is supported so as to enable movement. That is, it is possible to turn the switch 6 on by pressing the manipulation surface 5.

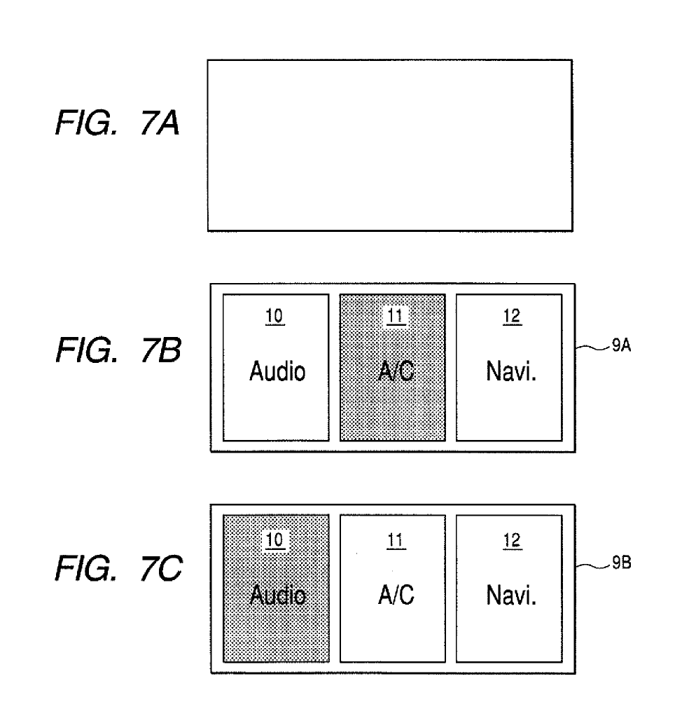

In addition, in one embodiment, as a display unit which is configured to display the functional item selected by the CPU 7 (functional item selecting unit), for example, a display device 9 including a liquid display device (LCD) is included. The display device 9 is configured in advance so that an icon 10 “Audio”, an icon 11 “A/C”, and an icon 12 “Navi.” are displayed in a screen in the above-mentioned step (FIGS. 7B-7C). In addition, the display device 9 is configured in advance so that an icon selected by the CPU 7 (functional item selecting unit) is more emphasized than other icons. In other words, the selected icon is highlighted to be distinguishable from the other, non-selected icons. For example, an icon indicating the selected functional item may have a default color differently from other icons.

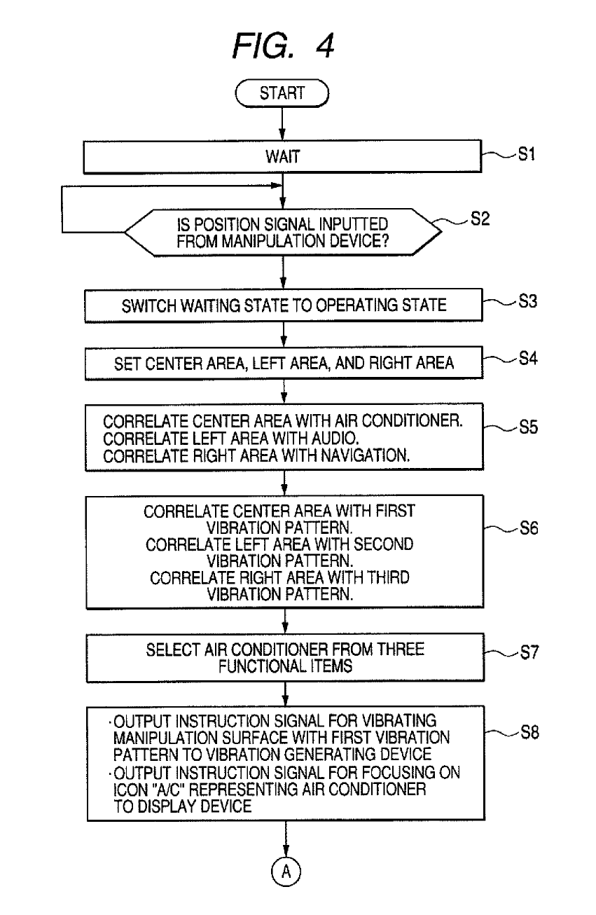

FIG. 3 is an example illustrating an installation of a display device 9 and a manipulation device 1 in an automobile according to the embodiment shown in FIG. 1. The manipulation surface 5 of the manipulation device 1 is disposed on an upper surface of a console 15, for example, so as to be manipulated in a driver's seat or a passenger seat. In addition, the display device 9 is disposed in an upper center of an instrument panel 16 so as to be watched in the driver's seat or the passenger seat.

In addition, as shown in FIG. 1, a vibration generating device 13 as controlled by a vibration generating unit is configured to vibrate the manipulation surface 5. The vibration generating unit 13 is fixed to the acryl panel 4 as shown in FIG. 2.

The CPU 7 functions as the vibration control unit so as to control the vibration generating device 13 by a program stored in the external memory device 8. The vibration control unit selects the vibration pattern indicating the functional item selected by the functional item selecting unit among the vibration patterns corresponding to the three functional items (air con, audio, navi) stored in advance. The vibration control unit controls the vibration generating device 13 so as to vibrate the manipulation surface 5.

The CPU 7 is configured to execute processes (5) and (6) so as to function as vibration control unit.

(5) The CPU 7 is configured in advance so that the first vibration pattern and the second vibration pattern are respectively correlated with the center area C, the left area L, and the right area R. Accordingly, as the first vibration pattern, the second vibration pattern, and the third vibration pattern are respectively correlated with the air con, the audio, and navi, the CPU 7 selects a vibration pattern indicating the functional items selected by the functional item selecting unit.

(6) When a position indicated by the position signal is within the center area C, the CPU 7 is configured so that an instruction signal for vibrating the manipulation surface 5 with the first vibration pattern is sent to the vibration generating device 13. When the position indicated by the position signal is within the left area L, the CPU 7 is configured so that an instruction signal for vibrating the manipulation surface 5 with the second vibration pattern is sent to the vibration generating device 13. When the position indicated by the position signal is within the right area R, the CPU 7 is configured so that an instruction signal for vibrating the manipulation surface 5 with the third vibration pattern is sent to the vibration generating device 13.

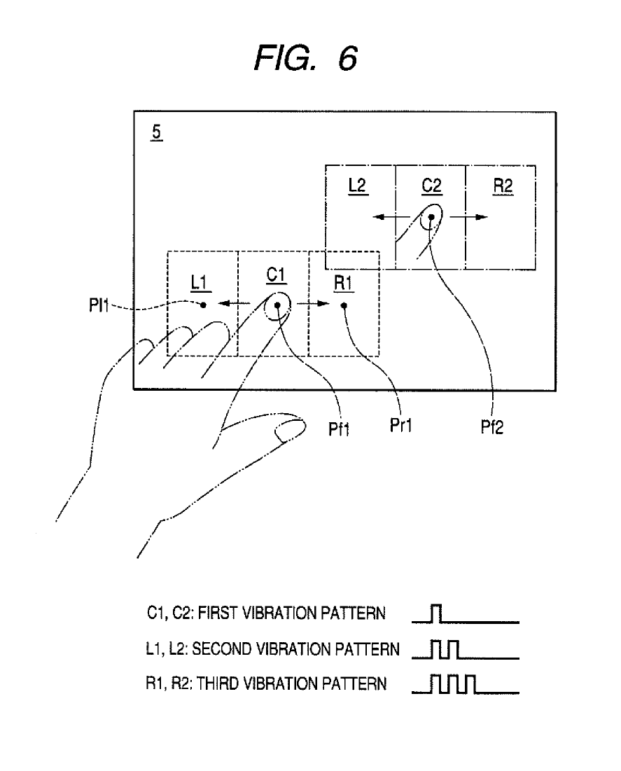

In addition, the pattern of the first, second, and third vibrations are made differently. In one embodiment, the first vibration pattern is a single vibration performed within a predetermined time, the second vibration pattern includes two vibrations performed within a predetermined time, and the third vibration pattern includes three vibrations performed within a predetermined time (FIG. 6).

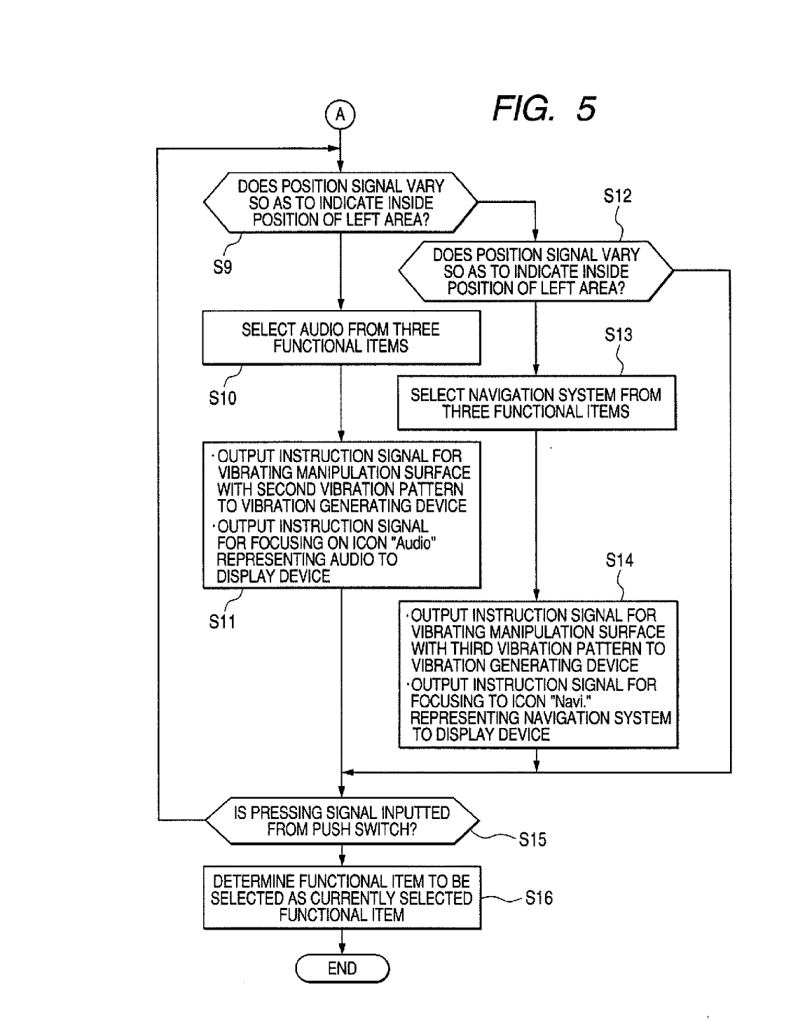

An operation of the embodiment as configured above will be described with reference to FIGS. 4 to 7. FIGS. 4 and 5 are connecting flow charts illustrating processing steps performed in a CPU as shown in FIG. 1. FIG. 6 is a diagram illustrating a corresponding relationship between a position on a manipulation surface touched by a finger of a user and a vibration pattern. FIG. 7 is a diagram illustrating an example of a screen varied by the process described in FIGS. 4 and 5.

When an accessory switch of an automobile (not shown) is turned on, the CPU 7 is operated. At this time, the CPU 7 operates as the functional item selecting unit and is converted into a waiting state where a signal from the manipulation device 1 may be inputted (step S1 of FIG. 4). In addition, when the CPU 7 is in the waiting state, the display device 9 is converted into a state where nothing is displayed like FIG. 7A.

As shown in FIG. 6, when the operator touches a predetermined position F1 on the manipulation surface 5 of the manipulation device 1, the touch sensor 2 detects an approach of the finger so as to output a position signal to the sensor IC 3 corresponding to the position near the manipulation surface 5 approximated by the finger. The sensor IC 3 converts the position signal into a position signal which can be processed in the CPU 7 and outputs the position signal to the CPU 7.

When the CPU 7 is in a waiting state is inputted from the sensor IC 3 of the manipulation device 1 (step S2: yes), the CPU 7 converts the process from the waiting state to the operating state (step S3).

Next, in the CPU 7 are configured the following areas (step S4): (1) a center area C1 of the rectangular, in which the initial position Pf1 is in the center, indicated by the position signal which caused conversion of the process from the waiting state to the operating state; (2) a left area L1; and (3) a right area R1 adjacent to the left area L1 and right of the center area C1.

Next, in the CPU 7, the center area C1 is correlated with the air con, the left area L1 is correlated with the audio, and the right area R1 is correlated with the navi (step S6).

Next, in the CPU 7, the center area C1 is correlated with the first vibration pattern, the left area L1 is correlated with the second vibration pattern, and the right area R1 is correlated with the third vibration pattern (step S6).

Next, the CPU 7 selects the air con among the three functional items (air con, audio, navi.) in one embodiment (step S7).

Next, the CPU 7 outputs the instruction signal for vibrating the manipulation surface 5 with the first vibration pattern to the vibration generating device 13 (step S8). In addition, in the CPU 7, the icon “audio” 10 indicating the audio, the icon “A/C” 11 indicating the air conditioner, and the icon “Navi.” 12 indicating the navigation are displayed in the step from left to right. In addition, the CPU 7 outputs the instruction signal to create a focus in (or highlight of) one of the icons 10, 11, 12 to the display device 9 (step S8).

The vibration generating device 13 inputted from the CPU 7 vibrates the manipulation surface 5 with the first vibration pattern. The operator recognizes that the air con is selected by the vibration of the first vibration pattern. In addition, the icons 10, 11, 12 are displayed in the step from left to right in the display device 9 in which the instruction signal is inputted from the CPU 7 (FIG. 7B). Accordingly, the screen 9 displays the icon “A/C” 11 with a focus or highlight. The operator recognizes that the air con is selected by seeing that the icon 11 “A/C” has the focus.

Next, for example, the operator moves the finger from the center area C1 to left area L1. At this time, the touch sensor 2 detects a position different from the initial position Pf1 and converts the position signal outputted from the sensor IC 3. The CPU 7 in which the converted position signal is inputted determines that the position signal is varied so as to indicate the position of an inside of the left area L1 (step S9 in FIG. 5). Now, since the position signal indicates the inside of the left area L1 (step S9: YES), the CPU 7 selects the audio among three functional items (step S10).

Next, the CPU 7 outputs a instruction signal for vibrating the manipulation surface 5 with the second vibration pattern to the vibration generating device 13 and outputs the instruction signal which has the focus (or highlight) to the icon 10 “Audio” to the display device 9 (step S11).

The vibration generating device 13 to which the instruction signal is inputted from the CPU 7 vibrates the manipulation surface 5 with the second vibration pattern. The operator recognizes that the audio is selected by the vibration of the second vibration pattern. In addition, since, as shown in FIG. 7C, the icons 10, 11, and 12 are displayed in the step form the left to the right in the display device 9 in which the instruction signal is inputted from the CPU 7, the icon 10 “Audio” is displayed in a screen having the focus or highlight. The operator recognizes that the audio is selected by seeing that the icon 10 “Audio” has a focus, or is highlighted, in the screen 9B.

Accordingly, the operator pushes the manipulation surface 5 and turns the push switch 6 on in a state where the audio is selected. The turned-on push switch 6 outputs the pressing signal to the CPU 7. The CPU 7 in which the pressing signal is inputted determines that the currently selected functional item, that is, the audio is actually selected as the functional item (the step S15: “YES”, the step S16 is performed).

In addition, after the step S8 of FIG. 4 ends, the operator moves the finger from the center area C1 to the right area R1. At this time, in the CPU 7, since the position signal indicates the position within the right area R1 (step S9: NO of FIG. 5→ step S12: YES), the CPU 7 selects the navigation among the three functional item (step 313).

Next, the CPU 7 outputs the vibration signal for vibrating the manipulation surface 5 with the third vibration pattern to the vibration generating device 13 and outputs the instruction signal to provide an emphasized focus (or highlight) in the icon 12 “Navi.” to the display device 9 (step S14).

The vibration generating device 13 to which the instruction signal is inputted from the CPU 7 vibrates the manipulation surface 5 with the second vibration pattern. The operator recognizes that the navigation is selected by the third vibration pattern.

In addition, the icons 10, 11, and 12 are displayed in the step from the left to the right in the display device 9 in which the instruction signal is inputted from the CPU 7. Accordingly, the operator recognizes that the navigation is selected by seeing that the icon 12 “Navi.” that is emphasized (or highlighted) is displayed in the screen (not shown).

Accordingly, the operator presses the manipulation surface 5 and turns the push switch 6 on in a state where the navi is selected. Accordingly, the CPU 7 in which the pressing signal is inputted from the push switch 6 determines that the navi is selected among the currently selected functional items (step S16)

In addition, after step S8 of FIG. 4 ends, for example, the operator presses the manipulation surface 5 and turns the push switch 6 on in a state where the operator moves her finger in the center area C1 (step S9: NO of FIG. 5→ step S12: NO→ step S15: YES). Accordingly, the CPU 7 determines that the currently selected functional item, that is, the air con is selected as the functional item (step S16).

In addition, when the operator does not turn the push switch 6 on in a state where none of the three functional items is selected (step S15 of FIG. 5: NO), the process is repeated from the steps S9 to S15.

After each of the three functional items are respectively correlated with the center area C1, the left area L1, and the right area R1 on the manipulation surface 5 by the CPU 7, the corresponding functional items are selected by the finger of the operator being positioned in one of the center area C1, the left area L1, and the right area R1.

In addition, when the operator approximates with his finger a different position on the manipulation surface 5 when the CPU 7 is in the waiting state, the CPU 7 is configured with the center area C2 having a rectangular shape with Pf2 positioned in the center thereof, a left area L2 which is adjacent to the center area C2 in a left direction, and a right area R2 which is adjacent to the center area C2 in a right direction (step S1 of FIG. 4 → step S2: YES → step S3 → step S4).

According to these embodiments, at least the following advantages will be obtained.

When the CPU 7 is in a waiting state as the functional item selecting unit, the operator touches the manipulation surface 5 by the finger, whereby a predetermined functional item, that is, an air conditioner (air con) is selected. In addition, as the relationship between the movement direction of the finger from the initial position Pf and the other functional items other than the predetermined functional item, that is, the audio and the navigation are constant, the operator easily stores the movement of the finger so as to select each of other functional items other than the predetermined functional item. Accordingly, the operator may easily approximate or touch the manipulation surface 5 without seeing the manipulation surface 5. Because the next process is the same as the above-mentioned process, the description will be omitted.

In addition, by the CPU 7 acting as the vibration control unit for the vibration generating device 13, the manipulation surface 5 is vibrated with the vibration pattern indicating the selected functional item by the CPU 7 acting as the functional item selecting unit. Accordingly, the operator may confirm whether the desirable functional item is selected or whether the vibration pattern on the manipulation surface 5 is correlated with the desirable functional item. Accordingly, the operation ends without seeing the selected functional item.

Also as mentioned, the selecting manipulation of the functional item is easily performed without seeing the manipulation surface 5 of the manipulation device 1 or the screen displayed by the display device 9. Accordingly, it is possible to enhance the manipulation of the touch operation input device and to do so safely when driving an automobile.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

What is claimed is:

1. A touch operation input device comprising:
an input unit having a manipulation surface to sense the presence of a finger and to output a position signal indicating a position on the manipulation surface approached by the finger;
a functional item selecting unit which selects a functional item among a plurality of functional items on the basis of the position signal;
a vibration generating unit which vibrates the manipulation surface; and
a vibration control unit which controls the vibration generating unit,
wherein the functional item selecting unit is configured to correlate a predetermined functional item among the plurality of functional items with an initial area including an initial position on the manipulation surface for selection, and to respectively correlate the functional items other than the predetermined functional item with other areas including predetermined positions in known relationship with the initial area,
wherein the functional item selecting unit selects the predetermined functional item when a position indicated by the position signal is within the initial area, and
wherein the vibration control unit selects a vibration pattern indicating the functional item selected by the functional item selecting unit among a plurality of vibration patterns.

2. The device of claim 1, wherein the functional item selecting unit selects a functional item correlated with other areas among the plurality of other functional items when the position indicated by the position signal is within one of the other areas.

3. The device of claim 1, wherein the vibration control unit is configured to control the vibration generating unit so that the manipulation surface is vibrated with the selected vibration pattern

4. The device of claim 1, wherein the functional items comprise items selected from among an air conditioner, a navigation system, audio, and video.

5. The device of claim 1, wherein the predetermined functional item is correlated with one of the other functional items, and another one of the other functional items is designated as the predetermined functional item.

6. The device of claim 1, wherein the known relationship with the initial area is adjacent thereto.

7. The device of claim 1, further comprising:
a display screen to display indicia of the plurality of functional items in their relative positions, and to highlight the indicia of the selected functional item.

8. A method for detecting selection from among a plurality of functional items in a touch operation input device, comprising:
configuring a processor to correlate position signals of a manipulation surface with a plurality of sensing areas corresponding to a plurality of functional items, wherein the positions are in known relationship to each other;
detecting the approach of a finger of an operator of the input device by a sensor of the manipulation surface;
sending a position signal corresponding to a position detected near the manipulation surface approximated by the finger from the sensor to the processor, wherein the processor enters an operation state to select a functional item that correlates to the detected position; and
vibrating the manipulation surface with a vibration pattern stored in a memory and pre-correlated with the detected position.

9. The method of claim 8, further comprising:
displaying a plurality of indicia respectively corresponding to the plurality of functional items on a display screen viewable by the operator; and
highlighting the indicia corresponding to the functional item that correlates to the detected position.

10. The method of claim 8, further comprising:
detecting a shift of the finger to another sensing area of the manipulation surface;
sending an updated position signal corresponding to a position near the manipulation surface approximated by the shift in the finger from the sensor to the processor;
selecting a functional item that correlates to the newly detected position; and
emphasizing an indicia corresponding to the newly selected functional item among a plurality of indicia displayed on a display screen that correspond to the plurality of functional items.

11. The method of claim 10, wherein the vibration pattern is a first vibration pattern, further comprising:
vibrating the manipulation surface with a second vibration pattern stored in the memory and pre-correlated with the newly detected position.
